(19) United States
(12) Patent Application Publication
(10) Pub. No.: US 2020/0122985 A1
(43) Pub. Date: Apr. 23, 2020

(54) A STABILIZER LEG DEVICE

(71) Applicant: Cargotec Patenter AB, Ljungby (SE)

(72) Inventor: Erik NYLANDER, Hudiksvall (SE)

(21) Appl. No.: 16/500,275

(22) PCT Filed: Mar. 28, 2018
(86) PCT No.: PCT/EP2018/057937

§ 371 Date: Oct. 2, 2019

(30) Foreign Application Priority Data
Apr. 3, 2017 (EP) 17164484.2

(51) Int. Cl. B66C 23/80; B60S 9/12

(52) U.S. Cl. CPC B66C 23/80; B66C 23/36; B60S 9/12

(57) ABSTRACT

A stabilizer leg device with a stabilizer leg to be moved downwards from an object so as to stabilize the object by bearing through a footplate (7) on the ground (20). The device comprises a holder (8) fixed to the object and receiving and holding a first stabilizer leg member (9) vertically displaceable. A first power member (10) displaces the first stabilizer leg member in relation to the holder. A second power member (11) displaces a second stabilizer leg member (12), and thereby the footplate (7) at the end thereof, in relation to the first stabilizer leg member (9). A locking arrangement will automatically lock the first stabilizer leg member in relation to the holder against vertical movements with respect thereto when the second stabilizer leg member (12) reaches a given position when moving downwards and automatically transfer the locking arrangement into an unlocked state when retracting the second stabilizer leg member (12) beyond said position.

### TECHNICAL FIELD OF THE INVENTION AND BACKGROUND ART

The present invention relates to a stabilizer leg device according to the preamble of claim 1 with a stabilizer leg to be moved downwards from an object, such as a crane vehicle, so as to stabilize this object by bearing through a footplate secured to a lower end of the stabilizer leg onto a support layer on which the object is resting.

Such a stabilizer leg device is normally a part of a support arrangement fixed to such an object, such as a moveable crane construction, by a frame structure to which one or more such stabilizer leg devices are secured for stabilizing the crane construction when this has to carry out work.

Such stabilizer leg devices of this type are known through EP 2 055 664 A1 and JP 2013075753 and the movement of the first stabilizer leg member in the form of a vertical displacement in relation to said holder and by that in relation to the object, such as the crane vehicle, constitutes an advantage in relation to stabilizer leg devices where the stabilizer leg is tilted around a horizontal axis to and from a working position of the stabilizer leg device, which may be problematic when the space for parking said object with the stabilizer leg device or devices is limited.

Furthermore, the displacement of the first stabilizer leg member in relation to the holder by the action of said first power member, such as a hydraulic cylinder, to a lower end position and then locking the first stabilizer leg member in relation to the holder in this position makes it possible to use a rather “weak” such first power member and thereby a first power member with a low demand of space, which is of advantage where space is limited.

In spite of these advantages of the known stabilizer leg devices, the locking arrangements thereof leave a great deal to desire with respect to reliability and simplicity of obtaining locking and unlocking states thereof, since the locking and unlocking actions have to be carried out by man power, for instance by inserting a pin in a recess or removing it therefrom.

### SUMMARY OF THE INVENTION

The object of the present invention is to provide a stabilizer leg device of the type defined in the introduction that is improved in at least some aspect in relation to such stabilizer leg devices already known.

This object is according to the invention achieved by providing such a stabilizer leg device with the features listed in the characterizing part of appended patent claim 1.

An automatic locking of said first stabilizer leg member in the lower end position in the working position of the stabilizer leg device and an automatic unlocking when transferring the stabilizer leg device from said working position is obtained through these features. The reliability of the locking and unlocking actions will be high and time and trouble are saved by requiring no hand-operation for carrying out the locking and unlocking actions. Accordingly, this is enabled by a member interconnecting the locking arrangement and the second stabilizer leg member to make the state of the locking arrangement dependent upon the vertical distance of the footplate to the first stabilizer leg member by automatically transferring the locking arrangement into the locking state upon displacement of the footplate downwards towards a working position of the stabilizer leg device and reaching a given extension degree of the second stabilizer leg member, and upon retracting the second stabilizer leg member from a working position of the stabilizer leg device and passing said given extension degree automatically transferring the locking arrangement into an unlocked state enabling upwards movement of the first stabilizer leg member in relation to the holder.

According to an embodiment of the invention said interconnecting member comprises at least one stiff elongated member, such as a rod, having one end connected to said footplate. This constitutes a simple and reliable way of accomplishing an interconnection of the locking arrangement and the second stabilizer leg member to make the state of the locking arrangement dependent upon the vertical distance of the footplate to the first stabilizer leg member. It is pointed out that “connected to said footplate” here is to be interpreted to cover also the case in which one end of said stiff elongated member is operatively connected to the footplate as long as the extension degree of the second stabilizer leg member does not exceed said given extension degree, but the end of the stiff elongated member may leave contact with the footplate for extensions of the second stabilizer leg member beyond said given extension degree.

According to another embodiment of the invention said at least one stiff elongated member has an upper end connected to one of said two locking members to cause movement thereof upon movement of the second stabilizer leg member in relation to the first stabilizer leg member. The two locking members of the locking arrangement may by this be moved between a locked and unlocked state by movement of the stiff elongated member due to movement of the second stabilizer leg member in relation to the first stabilizer leg member.

According to another embodiment of the invention the locking arrangement comprises at least one spring member storing potential energy in said unlocked state, and said interconnecting member is configured to release the spring member upon extension of the second stabilizer leg member from the first stabilizer leg member for urging one of said locking members into engagement with the other locking member and keeping the locking members in the locking state under pretention. This is a favorable way of obtaining automatic locking and unlocking of the first stabilizer leg member in relation to the holder.

According to another embodiment of the invention the locking arrangement is configured to obtain said locking engagement by a movement of one of the locking members transversally to the vertical extension of the stabilizer leg.

According to another embodiment of the invention the interconnecting member is configured to cause movement of said second locking member upon extension and retraction of the second stabilizer leg member in relation to the first stabilizer leg member. Said first locking member may then according to another embodiment of the invention comprise a recess in the first stabilizer leg member to be engaged by the second locking member in said locking state. Alternatively, the interconnecting member may in another embodiment of the invention be configured to cause movement of the first locking member upon extension and retraction of the second stabilizer leg member in relation to the first stabilizer leg member.

In a further development of the last-mentioned embodiment, the second locking member comprises a recess in the holder and the interconnecting member is configured, upon extension and retraction of the second stabilizer leg member with respect to the first stabilizer leg member, to move the first locking member into and out of locking state engagement in the holder recess.

According to another embodiment of the invention, the first locking member is a non-circular, such as oval, plate-like member and the second locking member comprises a correspondingly shaped opening into a room in the holder, wherein said plate-like member is configured to be received in said room in the lower end position of the first stabilizer leg member, and the control arrangement is configured to obtain said locking state by causing turning of said plate-like member around a center axis of the first stabilizer leg member.

According to another embodiment of the invention a power cylinder of the second power member forms the first stabilizer leg member and the second stabilizer leg member is a piston rod belonging to that power cylinder, wherein one or both of said power members may be a hydraulic cylinder.

The invention also relates to a support arrangement and a moveable crane construction according to the appended claims 13 and 14, respectively. The advantages of such an arrangement and such a construction appear clearly from the above discussion of the stabilizer leg device according to the present invention.

Further advantages as well as advantageous features of the invention will appear from the description following below.

### BRIEF DESCRIPTION OF THE DRAWINGS

With reference to the appended drawings, below follows a specific description of embodiments of the invention cited as examples.

In the drawings:

FIG. 1 is a schematic view of a crane vehicle provided with two stabilizer leg devices according to the invention in an inactive state,

FIG. 2 is a view of the crane vehicle in FIG. 1 with the two stabilizer leg devices in a working position stabilizing the vehicle by bearing through a footplate onto the ground,

FIG. 3 is a view of a stabilizer leg device according to a first embodiment of the invention in a parking position corresponding to that of FIG. 1,

FIG. 4 is a view corresponding to FIG. 3 with the first stabilizer leg member of the stabilizer leg device in a lower end position in relation to the holder,

FIG. 5 is a view of the stabilizer leg device in the position in FIG. 4, as seen in the direction of the arrow A in FIG. 4,

FIG. 6 is a view corresponding to FIG. 4 of the stabilizer leg device in a position in which the locking arrangement thereof automatically locks the first stabilizer leg member in relation to the holder,

FIG. 7 is a view of the stabilizer leg device in a working position with the footplate resting on the ground,

FIG. 8 is a view corresponding to FIG. 5 of the stabilizer leg device in the position shown in FIG. 7,

FIGS. 9 and 10 are cross-section views through the holder and the first stabilizer leg member of the stabilizer leg device with the locking arrangement thereof in an unlocked state and a locked state, respectively,

FIGS. 11 and 12 are views of a part of a stabilizer leg device according to a second embodiment of the invention with the locking arrangement thereof in an unlocked state corresponding to FIGS. 5 and 9, and

FIGS. 13 and 14 are view corresponding to FIGS. 11 and 12, respectively, of the stabilizer leg device with the locking arrangement in the locked state.

### DETAILED DESCRIPTION OF EMBODIMENTS OF THE INVENTION

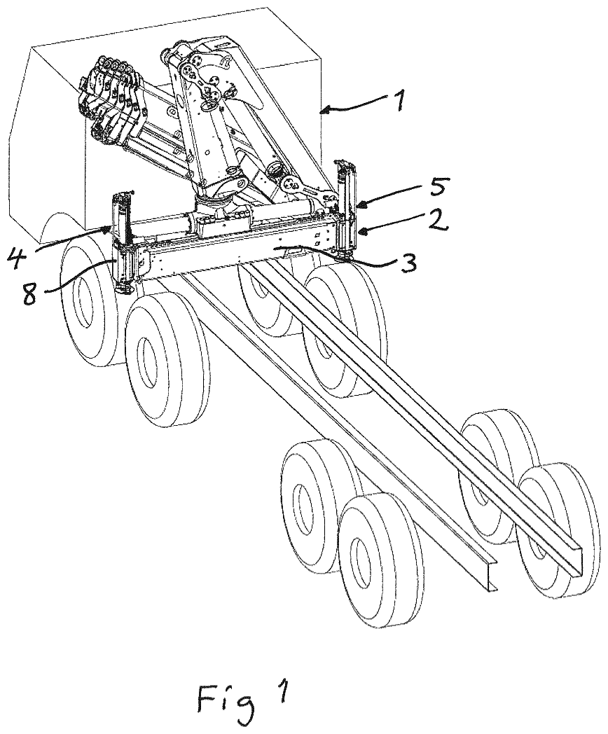

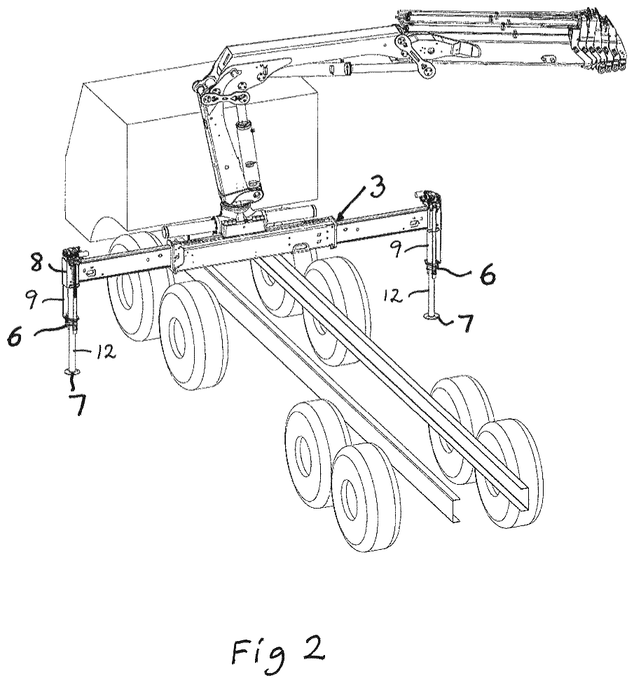

FIG. 1 schematically shows an object 1 in the form of a crane vehicle to which a support arrangement 2 is fixed by having a frame structure 3 thereof fixed to the frame work of the vehicle. The support arrangement is provided with two stabilizer leg devices 4, 5 according to a first embodiment of the invention. Each stabilizer leg device has a stabilizer leg 6 to be moved downwards from the crane vehicle so as to stabilize the crane vehicle by bearing through a footplate 7 secured to a lower end of the stabilizer leg onto the ground on which the vehicle is resting in a working position of the stabilizer leg device, as shown in FIG. 2.

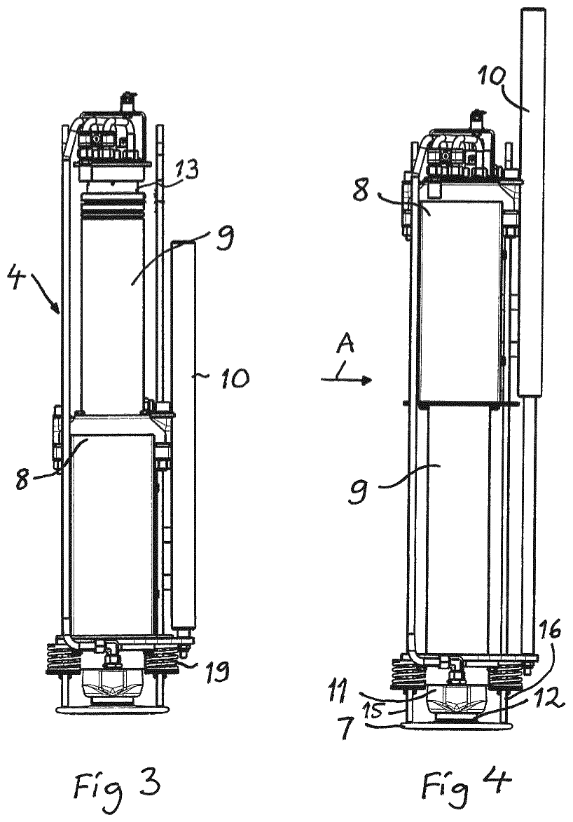

The design and function of a stabilizer leg device according to the first embodiment of the invention will now be described while making reference to FIGS. 3-10. The stabilizer leg device comprises a holder 8 configured to be fixed in relation to the crane vehicle. In the example illustrated in FIGS. 1 and 2, the holder 8 is secured to the frame structure 3 of the support arrangement. The holder 8 is configured to receive and hold a first member 9 of the stabilizer leg vertically displaceable in relation to the holder. A first power member 10, such as a hydraulic cylinder, is configured to act between the crane vehicle and the first stabilizer leg member 9 below the holder 8 by varying its length so as to displace the first stabilizer leg member vertically upwards and downwards in relation to the holder. The first stabilizer leg member 9 is moved downwards in relation to the holder 8 when the length of the first power member 10 is increased and upwards in relation to the holder 8 when the length of the first power member 10 is reduced. FIG. 3 illustrates the stabilizer leg device 4 in a parking position corresponding to the position shown in FIG. 1, whereas FIG. 4 shows how the first power member 10 has displaced the first stabilizer leg member 9 in relation to the holder 8 down to a lower end position. The device also comprises a second power member 11 belonging to the stabilizer leg and configured to change the distance between an upper end of the first stabilizer leg member 9 and the footplate 7 by varying its length and by that extend or retract a second stabilizer leg member 12 provided with the footplate in relation to the first stabilizer leg member 9. The second stabilizer leg member 12 is moved downwards in relation to the first stabilizer leg member 9 when the length of the second power member 11 is increased and upwards in relation to the first stabilizer leg member 9 when the length of the second power member 11 is reduced. The second power member 11 has said first stabilizer leg member 9 as power cylinder and the second stabilizer leg member 12 as piston rod belonging to that power cylinder. The footplate 7 is fixed to the second stabilizer leg member 12 at the lower end thereof.

The stabilizer leg device has also a locking arrangement which will now be described while making reference to FIGS. 3-10. In a working position of the stabilizer leg device with the first stabilizer leg member 9 in a lower end position (see FIG. 2), the locking arrangement is configured to lock the first stabilizer leg member 9 in relation to the holder 8 against vertical movements with respect thereto. The locking arrangement comprises for this sake a first locking member 13 (see FIG. 3) in the form of a recess or groove in the first stabilizer leg member 9 and at least one second locking member 14 on the holder 8 configured to engage with the first locking member 13 in a locking state of the locking arrangement. In the embodiment illustrated in FIGS. 3-10, there are two second locking members 14 moveably mounted to the holder 8 opposite each other and configured for engagement with the first locking member 13 on the first stabilizer leg member 9 in the locking state of the locking arrangement. The stabilizer leg device has a control arrangement configured to transfer the locking arrangement into a locking state by causing mutual engagement of the first and second locking members 13, 14 and into an unlocked state by releasing the mutual engagement of the first and second locking members.

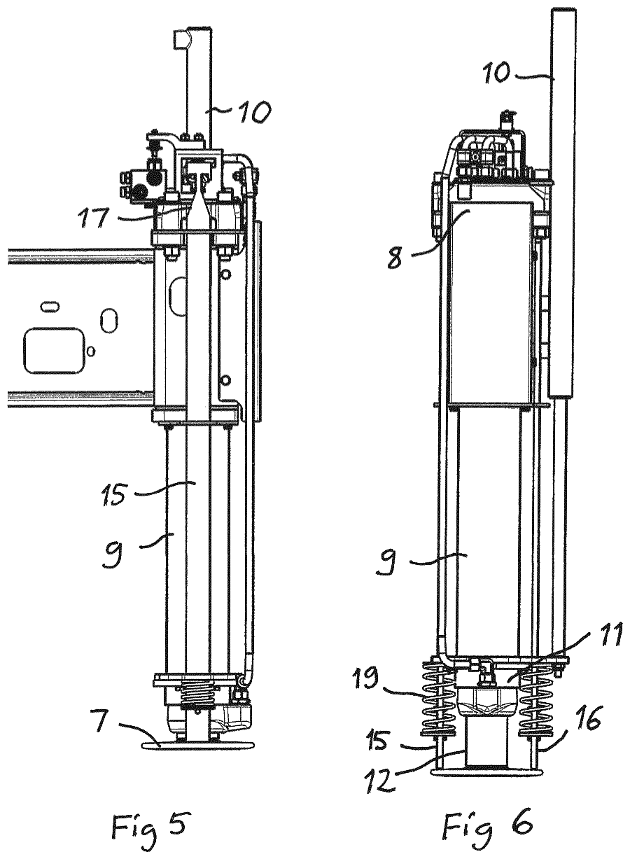

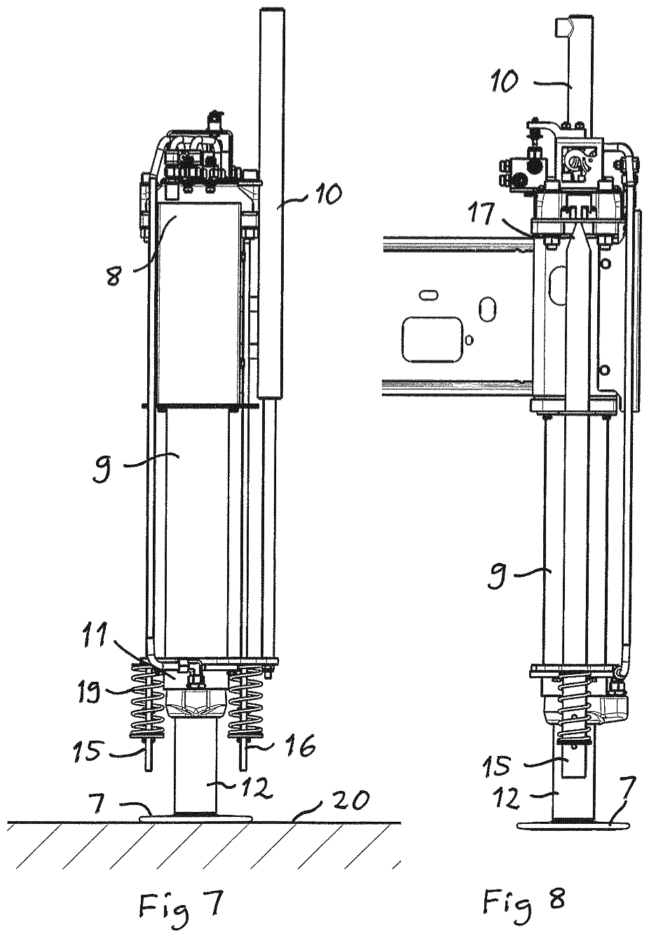

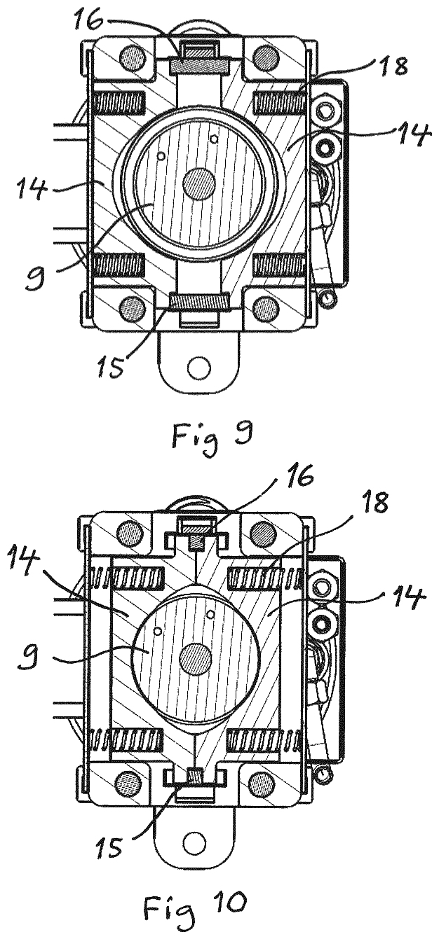

Said control arrangement comprises a member interconnecting the locking arrangement and the second stabilizer leg member 12 to make the state of the locking arrangement dependent upon the vertical distance of the footplate 7 to the first stabilizer leg member 9 by automatically transferring the locking arrangement into said locking state upon displacing the footplate downwards towards a working position of the stabilizer leg device and reaching a given extension degree of the second stabilizer leg member 12 shown in FIG. 6. The interconnecting member comprises two stiff elongated members 15, 16, such as rods, having one end bearing under pretension onto the footplate 7 in the retracted position of the second stabilizer leg member 12, as shown in FIGS. 3-5. Each elongated member 15, 16 has a cross-section with an upper end portion 17 (see FIG. 5) tapering towards the end. It is shown in FIG. 5 and FIG. 9 how a full cross-section portion of the stiff elongated members 15 and 16 projects through the locking arrangement and keeps the second locking members 14 apart against action of spring members 18 which are storing potential energy in the unlocked state of the locking arrangement. When the second power member 11 moves the second stabilizer leg member 12 and by that the footplate 7 downwards from the position shown in FIG. 5, the stiff elongated members 15, 16 will follow the footplate downwards thanks to spring members 19 to the position shown in FIG. 6, in which the end portions 17 of the stiff elongated members 15, 16 will be arranged between the second locking members 14 which will by that be urged by the spring members 18 to move to a locked position shown in FIG. 10 by engaging into the recess 13 in the first stabilizer leg member 9. This is also illustrated by the position of the stiff elongated member 15 shown in FIG. 8.

Thus, when the second stabilizer leg member 12, and by that the footplate 7, reaches the position shown in FIG. 6, the first stabilizer leg member 9 will automatically be locked in relation to the holder 8 under the effect of the first and second locking members 13, 14, and further extension of the stabilizer leg will be obtained by displacing the second stabilizer leg member 12 downwards in relation to the first stabilizer leg member 9 and thereby in relation to the holder 8 and the frame structure of the support arrangement. Such extension will then be carried out until a working position of the stabilizer leg device is reached by reaching the ground by the footplate 7. The function of the locking arrangement means that the first power member 10 has not to be dimensioned to withstand any forces in the working position of the stabilizer leg device shown in FIG. 7, since the second power member 11 will alone take care of this.

When the stabilizer leg device is to be transferred from the working position shown in FIG. 2 to a parking or driving position shown in FIG. 1, the second power member 11 is controlled to retract the second stabilizer leg member 12 from the position shown in FIG. 7, wherein the second stabilizer leg member 12, when passing said given extension degree shown in FIG. 6, will bring the footplate 7 to hit the stiff elongated members 15, 16 and automatically transfer the locking arrangement into an unlocked state by moving these members 15, 16 upwards and thereby enable upwards movement of the first stabilizer leg member 9 in relation to the holder 8 by actuation of the first power member 10.

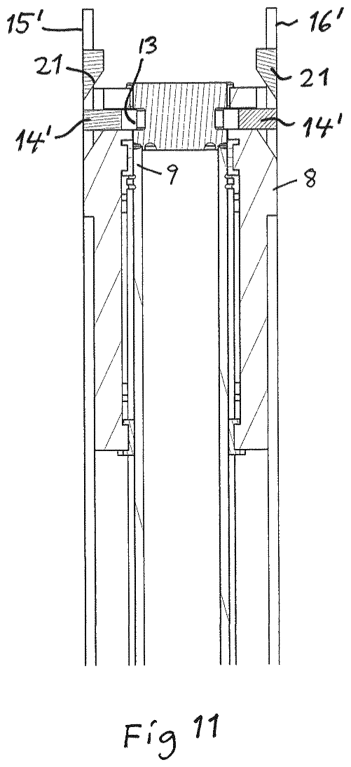

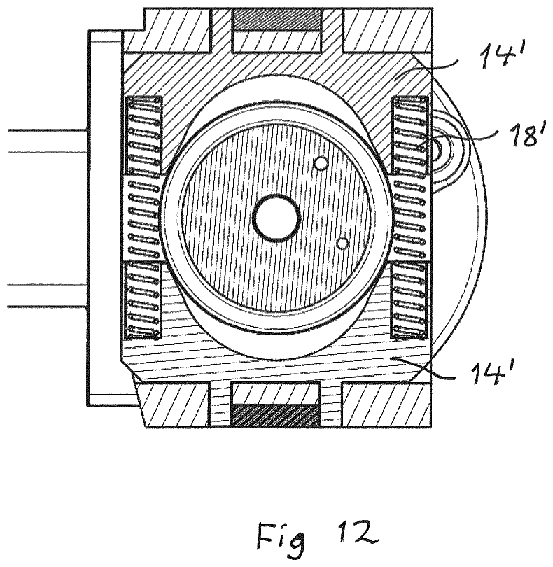

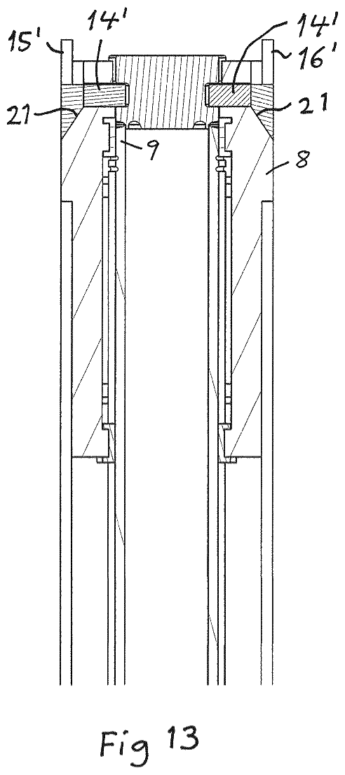

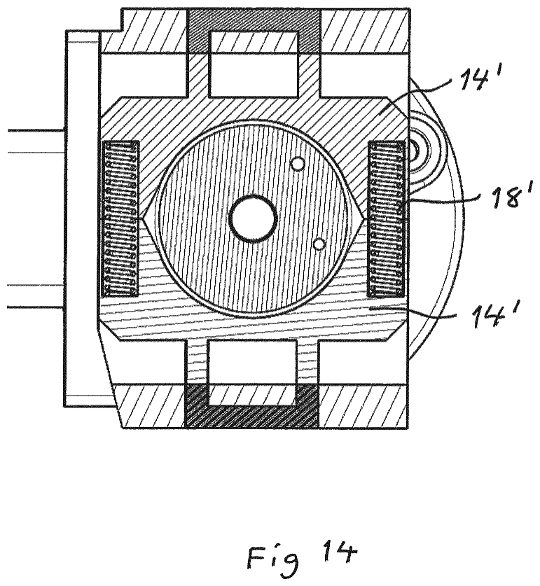

FIG. 11-14 illustrate the function of the locking arrangement in a stabilizer leg device according to a second embodiment of the invention where spring members 18′ are urging second locking members 14′ apart in an unlocked state, as shown in FIGS. 11 and 12. Stiff elongated members 15′, 16′ moved downwards from the parking position have wedge portions 21 acting upon the second locking members 14′ when reaching the position shown in FIG. 13 so as to then automatically lock the first stabilizer leg member 9 in relation to the holder 8 by moving the second locking members 14′ into a first locking member 13 in the form of a recess in the first stabilizer leg member 9, as also shown in FIG. 14. Retraction of the stabilizer leg from the working position will then when passing the position shown in FIG. 13 result in an automatic transfer of the locking arrangement into the unlocked state enabling retraction of the stabilizer leg to the parking position shown in FIG. 1.

The invention is of course in no way restricted to the embodiments described above, since many possibilities for modifications thereof are likely to be obvious to a person skilled in the art without having to deviate from the scope of invention defined in the appended claims.

The object to be stabilized by a stabilizer leg device according to the invention may be any type of object needing such a stabilization to stand safely without moving or any risk of tilting.

1. A stabilizer leg device with a stabilizer leg (6) to be moved downwards from an object (1), such as a crane vehicle, and stabilize this object by bearing through a footplate (7) secured to a lower end of the stabilizer leg onto a support layer (20) on which the object is resting, said device comprising:
a holder (8) configured to be fixed in relation to said object and to receive and hold a first member (9) of the stabilizer leg (6) vertically displaceable in relation to the holder,
a first power member (10) configured to act between said object and said first stabilizer leg member (9) below the holder (8) by varying its length and displace said first stabilizer leg member (9) vertically upwards and downwards in relation to the holder (8),
a second power member (11) belonging to the stabilizer leg and configured to change the distance between an upper end of the first stabilizer leg member (9) and said footplate (7) by varying its length and that extend or retract a second stabilizer leg member (12) provided with the footplate in relation to said first stabilizer leg member, and
a locking arrangement configured, in a working position of the stabilizer leg device with the first stabilizer leg member (9) in a lower end position, to lock the first stabilizer leg member in relation to the holder (8) against vertical movements with respect thereto, wherein
the locking arrangement comprises a first locking member (13) on the first stabilizer leg member (9) and a second locking member (14; 14′) on the holder (8),
the device further comprises a control arrangement configured to transfer the locking arrangement into a locking state by causing mutual engagement of said first and second locking members and into an unlocked state by releasing the engagement of the first and second locking members, and
the control arrangement comprises a member (15, 16; 15′, 16′) interconnecting the locking arrangement and said second stabilizer leg member (12) to make the state of the locking arrangement dependent upon the vertical distance of the footplate (7) to the first stabilizer leg member (9) by automatically transferring the locking arrangement into said locking state upon displacing the footplate (7) downwards towards a working position of the stabilizer leg device and reaching a given extension degree of the second stabilizer leg member (12), and upon retracting the second stabilizer leg member from a working position of the stabilizer leg device and passing said given extension degree automatically transferring the locking arrangement into an unlocked state enabling upwards movement of the first stabilizer leg member (9) in relation to the holder (8).

2. A stabilizer leg device according to claim 1, wherein said interconnecting member comprises at least one stiff elongated member (15, 16; 15′, 16′), such as a rod, having one end connected to said footplate (7).

3. A stabilizer leg device according to claim 2, wherein said at least one stiff elongated member (15, 16; 15′, 16′) has an upper end connected to one of said two locking members to cause movement thereof upon movement of the second stabilizer leg member (12) in relation to the first stabilizer leg member (9).

4. A stabilizer leg device according to claim 1, wherein
the locking arrangement comprises at least one spring member (18) storing potential energy in said unlocked state, and
said interconnecting member (15, 16) is configured to release the spring member upon extension of the second stabilizer leg member (12) from the first stabilizer leg member (9) for urging one (14) of said locking members into engagement with the other locking member (13) and keeping the locking members in the locking state under pretension.

5. A stabilizer leg device according to claim 4, wherein the locking arrangement is configured to obtain said locking engagement by a movement of one (14; 14′) of the locking members transversally to the vertical extension of the stabilizer leg (6).

6. A stabilizer leg device according to claim 1, wherein interconnecting member (15, 16; 15′, 16′) is configured to cause movement of said second locking member (14; 14′) upon extension and retraction of the second stabilizer leg member (12) in relation to the first stabilizer leg member (9).

7. A stabilizer leg device according to claim 6, wherein said first locking member comprises a recess (13) in the first stabilizer leg member (9) to be engaged by the second locking member (14; 14′) in said locking state.

8. A stabilizer leg device according to claim 1, wherein the interconnecting member is configured to cause movement of the first locking member upon extension and retraction of the second stabilizer leg member (12) in relation to the first stabilizer leg member (9).

9. A stabilizer leg device according to claim 8, wherein the second locking member comprises a recess in the holder (8) and the interconnecting member is configured, upon extension and retraction of the second stabilizer leg member (12) in relation to the first stabilizer leg member (9), to move the first locking member into and out of locking state engagement in the holder recess.

10. A stabilizer leg device according to claim 8, wherein
said first locking member is an non-circular, such as oval, plate-like member and the second locking member comprises a correspondingly shaped opening into a room in the holder,
said plate-like member is configured to be received in said room in the lower end position of the first stabilizer leg member, and
the control arrangement is configured to obtain said locking state by causing turning of said plate-like member around a center axis of the first stabilizer leg member.

11. A stabilizer leg device according to claim 1, wherein a power cylinder of said second power member (11) forms the first stabilizer leg member (9) and the second stabilizer leg member (12) is a piston rod belonging to that power cylinder.

12. A stabilizer leg device according to claim 11, wherein one or both of said power members (10, 11) are hydraulic cylinders.

13. A support arrangement configured to be fixed to an object, such as a crane vehicle, and give this object (1) support from a support layer (20) on which the object is resting, wherein the arrangement comprises a frame structure (3) configured to be fixed to said object and at least one stabilizer leg device (4, 5) according to claim 1 having the holder (8) thereof secured to the frame structure.

14. A moveable crane construction, such as a crane vehicle, comprising a support arrangement (2) according to claim 13.

15. A stabilizer leg device according to claim 3, wherein
the locking arrangement comprises at least one spring member (18) storing potential energy in said unlocked state, and
said interconnecting member (15, 16) is configured to release the spring member upon extension of the second stabilizer leg member (12) from the first stabilizer leg member (9) for urging one (14) of said locking members into engagement with the other locking member (13) and keeping the locking members in the locking state under pretension.

16. A stabilizer leg device according to claim 2, wherein
the locking arrangement comprises at least one spring member (18) storing potential energy in said unlocked state, and
said interconnecting member (15, 16) is configured to release the spring member upon extension of the second stabilizer leg member (12) from the first stabilizer leg member (9) for urging one (14) of said locking members into engagement with the other locking member (13) and keeping the locking members in the locking state under pretension.

17. A stabilizer leg device according to claim 16, wherein the locking arrangement is configured to obtain said locking engagement by a movement of one (14; 14′) of the locking members transversally to the vertical extension of the stabilizer leg (6).

18. A stabilizer leg device according to claim 15, wherein the locking arrangement is configured to obtain said locking engagement by a movement of one (14; 14′) of the locking members transversally to the vertical extension of the stabilizer leg (6).

19. A stabilizer leg device according to claim 18, wherein the interconnecting member (15, 16; 15′, 16′) is configured to cause movement of said second locking member (14; 14′) upon extension and retraction of the second stabilizer leg member (12) in relation to the first stabilizer leg member (9).

20. A stabilizer leg device according to claim 17, wherein the interconnecting member (15, 16; 15′, 16′) is configured to cause movement of said second locking member (14; 14′) upon extension and retraction of the second stabilizer leg member (12) in relation to the first stabilizer leg member (9).
